(19) United States
(12) Patent Application Publication
(10) Pub. No.: US 2013/0135205 A1
(43) Pub. Date: May 30, 2013

(54) Display Method And Terminal Device

(71) Applicant: Xiaobing Guo, Beijing (CN)

(72) Inventor: Xiaobing Guo, Beijing (CN)

(73) Assignee: Beijing Lenovo Software ltd., Haidian District, Beijing (CN)

(21) Appl. No.: 13/816,416

(22) PCT Filed: Aug. 15, 2011
(86) PCT No.: PCT/CN11/78407

§ 371 Date: Feb. 11, 2013

(30) Foreign Application Priority Data
Aug. 19, 2010 (CN) 201010258515.3

(51) Int. Cl. G06F 3/01

(52) U.S. Cl. CPC G06F 3/01
USPC 345/158

(57) ABSTRACT

The embodiments of the present disclosure provide a display method and a terminal device. The method includes detecting the state of the terminal device and displaying a first content on the display unit according to the first display command; producing a second display command when it is detected that the terminal devices is in the second state and displaying a second content on the display unit according to the second display command; wherein objects included in the first content and objects included in the second content are not exactly the same. The embodiments of the present disclosure produce different display commands according to the detected different states of the terminal device, and contents not exactly the same through the display unit, realizing that the terminal device displays different contents in different states, which improves the user's operation and experience.

The present disclosure relates to a technical field of display device, in particular to a display method and terminal device.

### BACKGROUND

A panel personal computer is regarded as a representative of the next generation of mobile PC. It is provided with all functions of a notebook computer. Besides, its mobility and portability are superior to those of the notebook computer.

Due to the characteristics of the panel personal computer, the existing desktop display method becomes incapable of matching with the characteristics of the panel personal computer. In the prior art, the desktop display method applied to a traditional PC is to set different desktop systems by a user, each of which may contain different display objects, for example, different application shortcuts. The user can enter into one desktop system or switch to another desktop system by means of entering a password or clicking. However, since this method for switching between different desktop systems is relatively complicated, it is currently in urgent need of a display method appropriate for the panel personal computer.

### SUMMARY

The embodiments of the present disclosure provide a display method and terminal device being able to be appropriate for a panel personal computer.

In order to solve the aforesaid technical problem. The embodiments of the present disclosure provide a display method to be applied to a terminal device. The terminal device comprises a display unit. The terminal device comprises at least a first state and a second state being differ from the first state. The method comprises:

Detecting a state of the terminal device;

Producing a first display command when it is detected that the terminal device is in the first state, and displaying a first content on the display unit according to the first display command;

Producing a second display command when it is detected that the terminal device is in the second state, and displaying a second content on the display unit according to the second display command;

Wherein objects included in the first content and objects included in the second content are not exactly the same.

Preferably, the terminal device further comprises a spatial position sensing unit. The method further comprises:

The spatial position sensing unit of the terminal device acquires spatial position information of the terminal device, and determines whether the terminal device is in the first state or in the second state according to the spatial position information.

Preferably, the terminal device further comprises an image acquiring unit. The method further comprises:

The image acquiring unit of the terminal device acquires image information nearby the terminal device, and determines whether the terminal device is in the first state or in the second state according to the image information.

Preferably, the objects included in the first content or the second content displayed on the display unit are in a forward direction relative to a user.

Preferably, the display command comprises a display object, a display position of the display object and a direction of the display object.

Preferably, the first content comprises a first object and a second object; the second content comprises the first object and a third object, wherein the second object and the third object are different.

Preferably, a display position of the first object is in a first region of the display unit, and a display position of the second object or the third object is in a second region of the display unit.

The embodiments of the present disclosure further provide a terminal device. The terminal device comprises at least a first state and a second state being differ from the first state. The terminal device comprises:

A storing unit for storing a first content and a second content of the terminal device, wherein objects included in the first content and objects included in the second content are not exactly the same;

A detecting unit for detecting a state of the terminal device;

A processing unit for producing a first display command when the detecting unit detects that the terminal device is in the first state, or producing a second display command when the detecting unit detects that the terminal device is in the second state;

A display unit for displaying the first content stored in the storing unit according to the first display command produced by the processing unit, or displaying the second content stored in the storing unit according to the second display command produced by the processing unit.

Preferably, the terminal device further comprises a spatial position sensing unit for acquiring spatial position information of the terminal device, determining whether the terminal device is in the first state or in the second state according to the spatial position information, and notifying the determined state to the detecting unit.

Preferably, the terminal device further comprises an image acquiring unit for acquiring image information nearby the terminal device, determining whether the terminal device is in the first state or in the second state according to the image information, and notifying the determined state to the detecting unit.

Preferably, objects included in the first content or the second content displayed on the display unit are in a forward direction relative to a user.

Preferably, the first content displayed on the display unit comprises a first object and a second object;

The second content displayed on the display unit comprises the first object and a third object;

Wherein the second object and the third object are different.

Preferably, a display position of the first object displayed on the display unit is in a first region of the display unit, and a display position of the second object or the third object is in a second region of the display unit.

Preferably, the second region displayed on the display unit is an edge region if the first region displayed on the display unit is a central region; or the second region displayed on the display unit is a central region if the first region displayed on the display unit is an edge region.

The embodiments of the present disclosure produce different display commands according to the detected different states of the terminal device, and display contents not exactly the same through the display unit, thus realizing that the terminal device displays different contents in different states, which gives convenience to users' operation and improves users' experience.

### BRIEF DESCRIPTION OF THE DRAWINGS

In order to more explicitly specify the technical solutions in the embodiments of the present disclosure or in the prior art, below will be a brief introduction of accompanying drawings needed to be used in descriptions of the embodiments or in the prior art. Obviously, the drawings in the below descriptions are merely some embodiments of the present disclosure. For those ordinarily skilled in the art, they may obtain other drawings in the light of these drawings, without paying any inventive labor.

FIG. 1 is a flow chart of a display method in the embodiments of the present disclosure;

FIG. 2 is a flow chart of a display method provided in the embodiment 1 of the present disclosure;

FIGS. 3a and 3b are illustrative diagrams of states of a terminal device in the embodiment as shown in FIG. 2;

FIG. 4 is a flow chart of a display method provided in the embodiment 2 of the present disclosure;

FIGS. 5a and 5b are illustrative diagrams of states of a terminal device in the embodiment as shown in FIG. 4;

FIG. 6 is an illustrative diagram of states of a terminal device in another embodiment of the present disclosure;

FIG. 7 is a flow chart of a display method provided in the embodiment 3 of the present disclosure;

FIGS. 8a-8d are illustrative diagrams of states of a panel personal computer in the embodiment as shown in FIG. 7;

FIG. 9 is an illustrative diagram of a structure of a first terminal device provided in the embodiments of the present disclosure;

FIG. 10 is an illustrative diagram of a structure of a second terminal device provided in the embodiments of the present disclosure; and

FIG. 11 is an illustrative diagram of a structure of a third terminal device provided in the embodiments of the present disclosure.

### DETAILED DESCRIPTION

In order to enable those skilled in the art to further understand the features and the technical contents of the present disclosure, below are provided in detail the descriptions and the accompanying drawings for reference. The accompanying drawings are merely used for referring and specifying rather than for limiting the present disclosure.

Below are descriptions of the technical solutions in the embodiments of the present disclosure by combining with the accompanying drawings and the embodiments.

Referring to FIG. 1, it is a flow chart of a display method in the embodiments of the present disclosure. The method is applied to a terminal device. The terminal device comprises a display unit. The terminal device comprises at least a first state and a second state being differ from the first state. The method comprises:

Step 101: detecting a state of the terminal device;

Step 102: producing a first display command when it is detected that the terminal device is in the first state, and displaying a first content on the display unit according to the first display command;

Step 103: producing a second display command when it is detected that the terminal device is in the second state, and displaying a second content on the display unit according to the second display command;

Wherein the terminal device may be any portable terminal device with a display unit, for example, a panel personal computer, an electronic reader, a handheld game machine, a smart phone, a GPS or PDA and so forth.

Wherein the first display command comprises at least a first display object, may further comprise a display position of the first display object, or may further comprises a direction of the first display object, or may further comprises the display position of the first display object and the direction of the first display object. The second display command comprises at least a second display object, may further comprise a display position of the second display object, or may further comprises a direction of the second display object, or may further comprise the display position of the second display object and the direction of the second display object.

Wherein the objects may be start-up shortcuts of programs stored in the terminal device, and may also be documents stored in the terminal device.

Wherein objects included in the first content and objects included in the second content are not exactly the same. That is, objects included in the first content and objects included in the second content may be completely different, or objects included in the first content and objects included in the second content may be partially the same.

Wherein when the terminal device comprises a spatial position sensing unit, the step of detecting a state of the terminal device comprises: the spatial position sensing unit of the terminal device acquires spatial position information of the terminal device, and determines whether the terminal device is in the first state or in the second state according to the spatial position information, wherein the spatial position sensing unit may be a gravity sensor, a torque sensor (detection a torque) or a gyroscope (detecting spatial direction) and so forth.

Wherein when the terminal device comprises an image acquiring unit, the step of detecting a state of the terminal device comprises: the image acquiring unit of the terminal device acquires image information nearby the terminal device, and determines whether the terminal device is in the first state or in the second state according to the image information, wherein the image information nearby the terminal device is image information within the acquisition region of the image acquiring unit and so forth.

Wherein objects included in the first content or the second content displayed on the display unit are in a forward direction relative to a user.

In the embodiment, the first content may comprise a first object and a second content; the second content may comprise the first object and a third object, wherein the second object and the third object are different.

In the embodiment, a display position of the first object is in a first region of the display unit, and a display position of the second object or the third object is in a second region of the display unit, wherein the second region is an edge region of the display unit if the first region is a central region of the display unit; of course, the positions of the first region and the second region may be random, for example, dividing in average the display unit into two approximately equal regions, one is the first region and the other is the second region.

In order to make it convenient for the understanding of those skilled in the art, bellow will be a specification through special embodiments.

### Embodiment 1

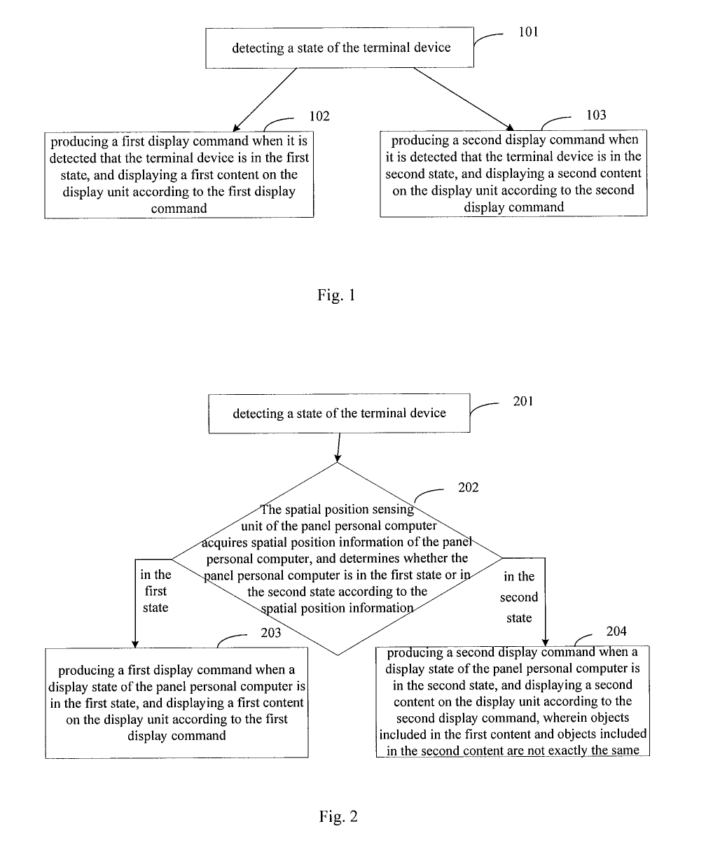

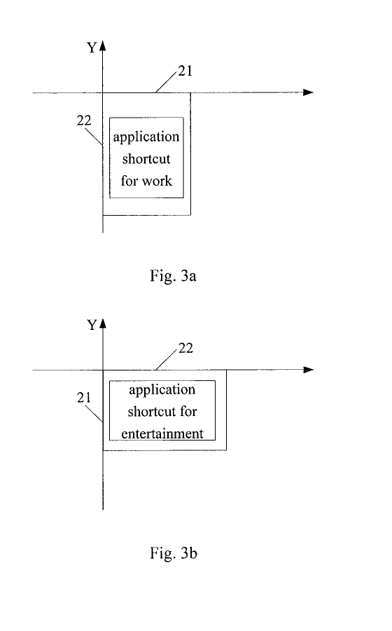

Referring to FIG. 2, it is a flow chart of a display method provided in the embodiment 1 of the present disclosure. FIGS. 3a and 3b are illustrative diagrams of states of a terminal device in the embodiment.

The method is applied to a terminal device. Taking a panel personal computer as an example, the display screen of the panel personal computer is commonly a rectangle with two adjacent sides 21 and 22. Of course, the length of the two adjacent sides may be equal, that is, the display screen of the panel personal computer is a square. The panel personal computer can possess two display states. In the present embodiment, as shown in FIG. 3a, when the side 21 of the panel personal computer is placed along X axis, i.e., being placed horizontally relative to the coordinate system, and the side 22 of the panel personal computer is placed along Y axis, i.e., being placed vertically relative to the coordinate system, the display state of the display screen of the terminal device is in a first state, in which the display angle is in parallel to the side 22. As shown in FIG. 3b, when the side 21 of the panel personal computer is placed along Y axis and the side 22 of the panel personal computer is placed along X axis, the display state of the display screen of the terminal device is in a second state, in which the display angle is in parallel to the side 21. As a result, the display angle in the first state and the display angle in the second state are approximately perpendicular to each other with the terminal device as a reference. Wherein, the X-Y coordinate system is a plane rectangular coordinate system. Of course, the display states of the panel personal computer are not limited to such two states, and also may be that the angle between the display angle in the first state and the display angle in the second state is any angle representative of the two states being not same (i.e., excluding 0 and 360 degrees) within the range of 0-360 degree, for example, the angle may be 45 degrees or 180 degrees and so forth.

In the present embodiment, the panel personal computer comprises a display unit, i.e., a display screen. The panel personal computer comprises at least the first state and the second state being differ from the first state. The method comprises:

Step 201: detecting a state of the panel personal computer;

Step 202: a spatial position sensing unit in the panel personal computer acquires spatial position information of the panel personal computer, and determines whether the panel personal computer is in the first state or in the second state according to the spatial position information.

Since the panel personal computer is used on a approximately horizontal plane in many occasions, it is thus unable to use a gravity sensor to detect. Therefore, in the present embodiment, a detection is performed through a micro torque sensor (i.e., a particular application of the spatial position sensing unit), for example, setting in advance that the first state and the second state correspond to their respective torque values. It can be detected that the torque value of the panel personal computer has changed when the panel personal computer is rotated. The state of the panel personal computer after the rotation of the panel personal computer can be determined according to the torque value of the panel personal computer before the rotation of the panel personal computer and the change of the torque value. In other embodiments, body feature information of a user (for example, human face image information) can be acquired using a camera (i.e., a particular application of the image acquiring unit), so as to compare the body feature information of the user and the pre-stored positioning information of the display state, and thus the current state of the panel personal computer can be determined, please referring to the subsequent descriptions of the embodiments for detail.

Step 203: producing a first display command when the display state of the panel personal computer is in the first state, and displaying a first content on the display unit according to the first display command;

At least two display contents are set in the panel personal computer of the present embodiment. Taking desktop systems as an example, the respective desktop systems have display objects being not exactly the same, that is, objects included in the first content and objects included in the second content are not exactly the same. Corresponding information of various states of the terminal device, display commands and desktop systems are stored in the panel personal computer, for example, by means of a corresponding list. Wherein the display command may comprise a display object, may further comprise a display position of the display object, and may further comprise a direction of the display object.

It is triggered to produce a first display command if the micro torque sensor detects that the current display state of the panel personal computer is in the first state, and then a desktop system corresponding to the first display command is obtained from the corresponding list according to the first display command. Further, the display screen of the panel personal computer can display the first content of the desktop system. As shown in FIG. 3a, in the present embodiment, objects included in the first content may be an application shortcut for work, for example, a shortcut for an e-mail box or data files for work and so forth.

Step 204: producing a second display command when the display state of the panel personal computer is in the second state, and displaying a second content on the display unit according to the second display command, wherein objects included in the first content and the second content are not exactly the same.

It is triggered to produce a second display command if the micro torque sensor detects that the current display state of the panel personal computer is in the second state, and then a desktop system corresponding to the second display command is obtained from the corresponding list according to the second display command. Further, the display screen of the panel personal computer can display the second content of the desktop system. As shown in FIG. 3b, in the present embodiment, objects included in the second content may be an application shortcut for entertainment, for example, a shortcut for games or film files for entertainment and so forth.

In the present embodiment, objects included in the first contents or the second content displayed on the display unit are in a forward direction relative to a user.

Objects included in the first content and object included in the second content being not exactly the same are specified as: the first content may comprise a first object and a second object, and the second content may comprise the first object and a third object, wherein the second object and the third object are different.

Wherein, a display position of the first object is in a first region of the display screen, and a display position of the second object or the third object is in a second region of the display screen. The second region displayed on the display unit is an edge region if the first region is a central region.

“First” and “second” in the embodiments of the present disclosure are merely used for distinguishing two display states or two display contents but not used for a specific reference or definition.

Based on the portability characteristic and the characteristics of being capable of being rotated randomly in a space or being viewed at any angle and so forth of the panel personal computer, the embodiments of the present disclosure has realized display of different contents in different display states by setting desktop systems corresponding to different display states in the panel personal computer and detecting a display state of the panel personal computer. When being used by a user, the user can enter into different desktop systems as long as he/she changes the viewing direction of the panel personal computer relative to the user, which gives convenience to users' operation and improves users' experience.

### Embodiment 2

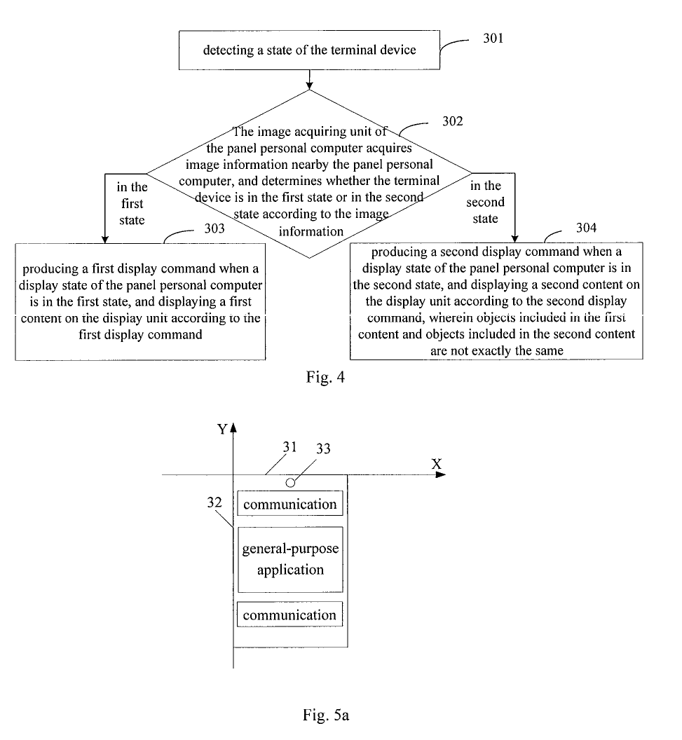

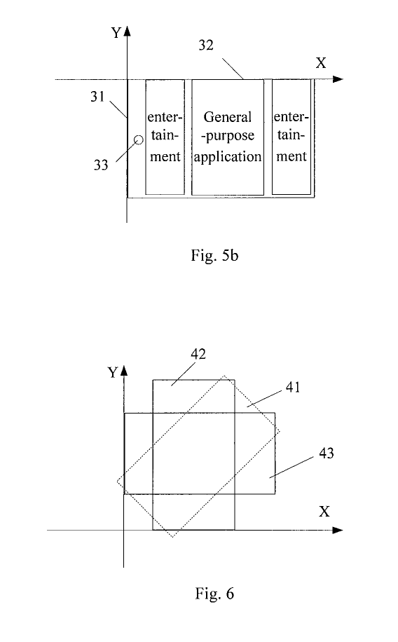

Referring to FIG. 4, it is a flow chart of a display method provided in the embodiment 2 of the present disclosure. FIGS. 5a and 5b are illustrative diagrams of states of a terminal device in the embodiment.

Also, the present embodiment takes a panel personal computer as an example. A display screen of the panel personal computer is still a rectangle with two adjacent sides 31 and 32. Of course, the length of the adjacent two sides may be equal, that is, the display screen of the panel personal computer is a square. A camera 33 is set on the display screen (the position of the camera as shown in the figure is just an example, and thus the position is not limited thereto). The panel personal computer in the present embodiment possesses a first state and a second state the same as those in the previous embodiment, taking display angles in the two display devices being perpendicular to each other as an example.

In the present embodiment, the desktop display method of the panel personal computer can comprise:

Step 301: detecting a state of the panel personal computer;

Step 302: an image acquiring unit (such as a camera) of the panel personal computer acquires image information nearby the panel personal computer, and determines whether the panel personal computer is in the first state or in the second state according to the image information.

A camera 33 is set at one side in a position close to the side 31 of the display screen of the panel personal computer, so that image information nearby the panel personal computer can be acquired at regular time or at real time, for example, human face image information of a user and so forth can be acquired. Then, the human face image information can be analyzed, for example, acquiring position information of eyes and mouth in the human face, drawing an isosceles triangle by taking an attachment between eyes as a hemline and taking a position of the mouth as a vertex, and taking a position and direction of the isosceles triangle relative to the panel personal computer as a direction for a user to view the panel personal computer, thus determining the display state of the panel personal computer to be appropriate for a user's viewing, that is, determining the display state by comparing the human face image information and the pre-stored positioning information of the display state.

A corresponding relationship of each of the display states and its positioning information can be pre-stored in the panel personal computer. In particular, it can be stored by means of a corresponding list, for example, positioning information corresponding to a first state is an inverted triangle A with the hemline upward and the vertex downward or a forward triangle B with the vertex upward and the hemline downward; positioning information corresponding to a second state is a horizontal triangle C with the hemline on the left and the vertex on the right or a triangle D with the vertex on the left and the hemline on the right.

In the present embodiment, if an inverted triangle with the hemline upward and the vertex downward is drawn according to the acquired human face image information, then based on a comparison of such a graphic with the positioning information of each of the display states, the graphic matches with the pre-stored graphic A. Thus, it can be determined that the current display state of the panel personal computer is the first state as shown in FIG. 5a. If the drawn triangle is a horizontal triangle with the hemline on the left and the vertex on the right, the graphic then matches with the pre-stored graphic C, and the current display state is the second state as shown in FIG. 5b. Of course, certain threshold of matching can also be set in the process of comparison described above. It will be deemed as matching if a difference produced from the comparison falls within the threshold.

Step 303: producing a first display command when the display state of the panel personal computer is in the first state, and displaying a first content on the display unit according to the first display command;

At least one desktop system is set in the panel personal computer of the present embodiment. Objects included in the desktop system possess shortcuts of a variety of applications, and corresponding information of each of the display states, display commands and application shortcuts can be stored in the panel personal computer, wherein the display command can comprise a display object and a display position and a direction of the display object. For example, it can be stored by means of a corresponding list as: a first state—a first display command—an e-mail box shortcut and a communication list shortcut and so forth; a second state—a second display command—an e-mail box shortcut and an online game shortcut and so forth. Of course, the display command may also comprise other objects, and the present embodiment does not define the other objects. Also, it can be directly indicated in attributes of each of the applications to be displayed only when the first display command is received, or to be displayed only when the second display command is received, or to be displayed no matter whether a first display command or a second display command is received.

Wherein objects of the first content or the second content displayed on the display unit are in a forward direction relative to a user.

It is triggered to produce a first display command if the display state of the panel personal computer is in the first state, and then corresponding shortcuts in the desktop system are obtained from a corresponding list for display according to the first display command, or attributes of each of the applications are traversed so as to determine whether the application is to be displayed. The display content is the first content as shown in FIG. 5a.

Step 304: producing a second display command when the display state of the panel personal computer is in the second state, and displaying a second content on the display unit according to the second display command.

It is triggered to produce a second display command if it can be determined that the current display state of the panel personal computer is in the second state, wherein the second display command can comprise a display object and a display position of the display object, and can further comprise a direction of the display object, and then corresponding shortcuts in the desktop system are obtained from the corresponding list for display, or attributes of each of the applications are traversed so as to determine whether the application is to be displayed. The display content is the second content as shown in FIG. 5b.

In the present embodiment, objects included in the first content and objects included in the second content can comprise a shortcut of the same application, for example, a general purpose application. Further, the shortcut of the same application can be displayed in a central region of the display screen, and shortcuts of different application are displayed in an edge region of the display screen, as shown in FIGS. 5a and 5b; and vice versa, to which the present embodiment does not limit.

In one embodiment as shown in FIG. 5a, the region marked with “communication” can be placed in the top and bottom edge regions of the display screen, while the region marked with “general purpose communication” can be placed in the central region of the display region; and vice versa.

In another embodiment as shown in FIG. 5b, the region marked with “entertainment” can be placed in the left and right edge regions of the display screen, while the region marked with “general purpose communication” can be placed in the central region of the display region; and vice versa.

Wherein in the present embodiment, the “communication” region or the “general purpose application” region can be representative of a shortcut of one application or a set of applications, but the embodiments of the present disclosure are not limited thereto.

The embodiments of the present disclosure has realized display of different contents in different display states by setting contents corresponding to different display states in desktop systems of the panel personal computer and acquiring a human face image to determine a current display state so as to obtain the corresponding content to be displayed in the current state. When being used by a use, the user can enter into different desktop systems as long as he/she views the display screen in different ways to enable the display screen to acquire a human face image, which gives convenience to users' operation and improves users' experience.

In the embodiment described above, two display states of the panel personal computer are determined merely according to positions of two sides 31 and 32 of the display screen. In another embodiment of the present disclosure, display states of the panel personal computer can be further divided into four types by combining with the position of the camera, for example, it is “a” display state when the side 31 is placed along X positive axis, the side 32 is paced along Y negative axis, and the camera is close to X positive axis; it is “b” display state when the side 31 is placed along X positive axis, the side 32 is placed along Y negative axis, and the camera is away from X positive axis; it is “c” display state when the side 32 is placed along X positive axis, the side 31 is placed along Y negative axis, and the camera is close to Y negative axis; it is “d” display state when the side 32 is placed along X positive axis, the side 31 is placed along Y negative axis, and the camera is away from Y negative axis. In such cases, a display state is determined by comparing a human face image and pre-stored positioning information of display states, that is, a display state of the panel personal computer can be determined by taking triangles A, B, C and D as positioning information of the four display states (a, b, c and d) respectively. Then, display contents in each of the display states can be displayed at a display angle corresponding to each of the display states.

In another embodiment of the present disclosure, in the acquisition of image information nearby the panel personal computer, besides acquiring body feature information of a user, it can further acquire position information of the user. In particular, it can acquire a position of the user relative to the display screen using an infrared photographic device or a sensor and so forth, for example, marking the position of the user from top (upward), bottom (downward), left and right on a plane the same as the display screen and with the display screen as a center, i.e, determining in which direction of the display screen the user (human body) is located. Then, the position information of the user and the pre-stored positioning information of display states are compared, based on which the display state of the terminal device can be determined. For example, if position information of the user is that the user is located at the top of the display screen, the determined display state corresponding thereto is the first state described above; if position information of the user is that the user is located on the right of the display screen, the determined display state corresponding thereto is the second state described above.

In another embodiment, based on the two embodiments described above, a panel personal computer can further possess other display states, for example, a display state possessed by an inclined placed display screen. As shown in FIG. 6, the angle between the display state 41 and the first state 42 is 45 degree and meanwhile the angle between the display state 41 and the second state 43 is also 45 degree. That is, when the display screen is placed on the bisector of the angle between X,Y positive axes in a plane orthogonal coordinate system, the display angle in this display state can be the same as that in the first state, or the display angle can be the same as that in the second state. Of course, other display angles can be set in advance. A third content displayed in this state may be differ from both a first content and a second content, containing shortcuts of completely different applications or shortcuts of not exactly the same applications, and also may be the same as the first content or the same as the second content, to which the present embodiment does not limit.

In the present embodiment, when the display state of the panel personal computer is detected, a rotating state of the panel personal computer can be detected through a torque sensor. Only when it is detected that the panel personal computer is rotated to the bisector of the angle between X,Y positive axes in a plane orthogonal coordinate system, it is triggered to produce a third display command, and a corresponding third content is obtained according to the third display command to be displayed at a display angle in the first state or in the second state. Of course, when the display state of the panel personal computer is detected, it can be determined by means of acquiring human face image information. Positioning information of a third display state is pre-stored in the panel personal computer, for example, an isosceles triangle with a center line of the hemline being placed along the bisector of the angle between X,Y positive axes. When the triangle drawn according to the acquired human face image matches with the positioning information, the current display state can be determined as the third display state and it can be triggered to produce the third display command. Then, a corresponding third content can be obtained according to the third display command to be display at a display angle in the first state or in the second state.

Since the third display state is not a commonly used state and there is a specific limitation to an angle of inclination of the display screen, shortcuts of applications needed to be kept secret can be set in the third content corresponding to the third display state. That is, using a particular spatial position or a particular user viewing angle as a triggering condition to display particular objects can increase security of a system. When other users know nothing of this particular angle, they will fail to view these hidden particular objects.

Further, in order to prevent other users from finding the particular triggering condition through a simple try, a timing unit can be further set. Only when the time during which the triggering condition is satisfied surpasses the predetermined time (such as 5 seconds), a corresponding object can be displayed.

In the embodiment described above, when the terminal device is in different display states, each of the display states corresponds to an exclusive display angle. After the display state of the terminal device is determined, a corresponding content can be displayed according to a given display angle. However, when the embodiment described above is applied to the occasion when a plurality of users view the display screen at different angles, for some users, the display angle of the display screen and their viewing angle may be opposite or perpendicular. For this reason, the embodiments of the present disclosure further provide another display method, with the specific embodiments as follows:

### Embodiment 3

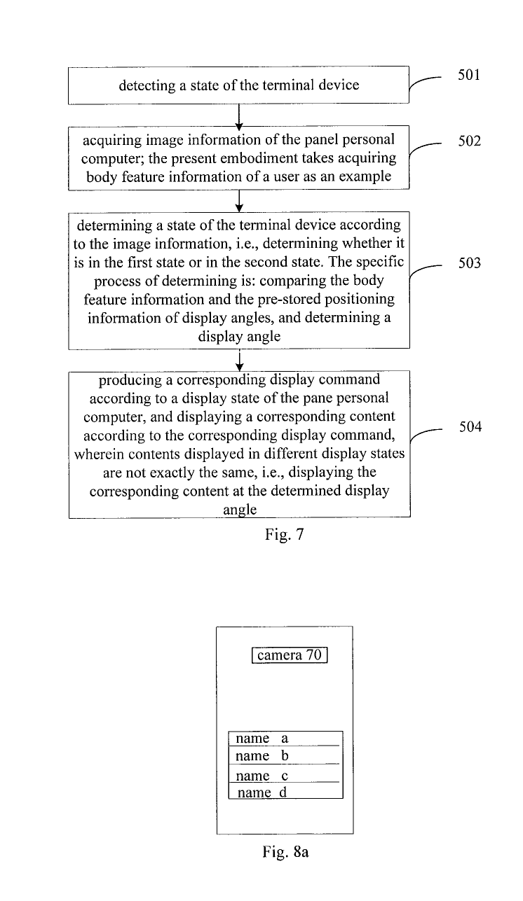

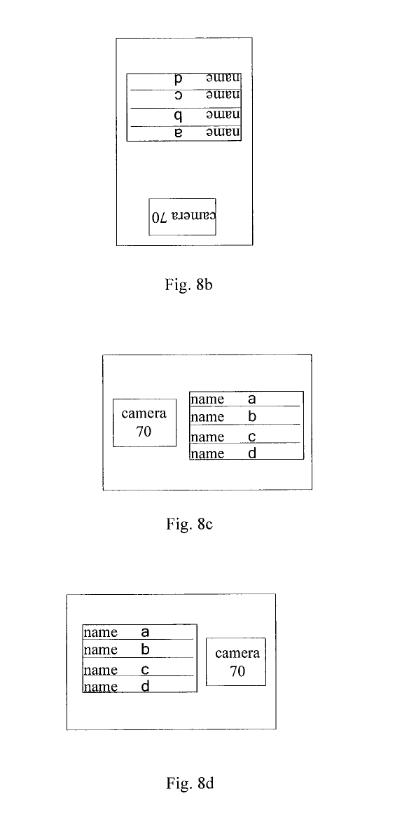

Referring to FIG. 7, it is a flow chart of a display method provided in the embodiment 3 of the present disclosure. FIGS. 8a-8d are illustrative diagrams of states of a panel personal computer in the present embodiment.

In the present embodiment, the display screen of the panel personal computer is commonly a rectangle with two adjacent sides. Of course, the length of the adjacent two sides may be equal, that is, the display screen of the panel personal computer is a square. A camera is set close to the side the display screen. The panel personal computer in any determined state can adopt the below method for display. The method can comprise:

Step 501: detecting a state of the panel personal computer;

Step 502: acquiring image information nearby the panel personal computer; the present embodiment takes acquiring body feature information of the user as an example;

In the present embodiment, the body feature information of the user is specified by taking human face image information of the user as an example. The camera 70 can acquire human face image information of the user at regular time or at real time. Then, the human face image information can be analyzed, for example, acquiring position information of eyes and mouth of the human face, and drawing an isosceles triangle by taking the attachment between eyes as a hemline and taking the position of the mouth as a vertex. In the present embodiment, this step aims at determining a viewing angle of the user.

Step 503: determining a state of the terminal device according to the image information, i.e., determining whether it is in the first state or in the second state. The specific process of determining is: comparing the body feature information and the pre-stored positioning information of display angles, and determining a display angle.

In the present embodiment, it is to compare the human face image information and the pre-stored positioning information of display angles and determine the display angle. A corresponding relationship between each of the display states and its positioning information can be pre-stored in the panel personal computer. In particular, it can be stored by means of a corresponding list, for example, positioning information corresponding to a first display angle is an inverted triangle A with a hemline upward and a vertex downward; positioning information corresponding to a second display angle is a forward triangle B with a vertex upward and a hemline downward; positioning information corresponding to a third display angle is a horizontal triangle C with a hemline on the left and a vertex on the right; and positioning information corresponding to a fourth display angle is a horizontal triangle D with a vertex on the left and a hemline on the right; and so forth.

Obtaining human face image information of the user, and then drawing a triangle, which is compared to positioning information of each of the display angles, so as to determine a display angle.

Step 504: producing a corresponding display command according to the display state of the pane personal computer, and displaying the corresponding content on the display unit according to the corresponding display command, wherein contents displayed in different display states are not exactly the same, i.e., displaying the corresponding content at the determined display angle.

If a graphic obtained from the human face image information of the user matches with a pre-stored graphic A, the panel personal computer displays a content at a first display angle if it is at an initial state, and the displayed content is not limited to a desktop content; if the pane personal computer displays a content at other display angles before acquiring the human face image, it switches to display the displayed content at the first display angle, taking an address list of the user as an example, as shown in FIG. 8a.

If a graphic obtained from the human face image information of the user matches with a pre-stored graphic B, the panel personal computer displays a content at a second display angle if it is at an initial state, and the displayed content is not limited to a desktop content; if the pane personal computer displays a content at other display angles before acquiring the human face image, it switches to display the displayed content at the second display angle, taking an address list of the user as an example, as shown in FIG. 8b.

If a graphic obtained from the human face image information of the user matches with a pre-stored graphic C, the panel personal computer displays a content at a third display angle if it is at an initial state, and the displayed content is not limited to a desktop content; if the pane personal computer displays a content at other display angles before acquiring the human face image, it switches to display the displayed content at the third display angle, taking an address list of the user as an example, as shown in FIG. 8c.

If a graphic obtained from the human face image information of the user matches with a pre-stored graphic D, the panel personal computer displays at a fourth display angle if it is at an initial state, and the displayed content is not limited to a desktop content; if the pane personal computer displays a content at other display angles before acquiring the human face image, it switches to display the displayed content at the fourth display angle, taking an address list of the user as an example, as shown in FIG. 8d; and so forth.

The embodiments of the present disclosure determine a viewing angle of the user by acquiring the human face image information of the user. Then, a display angle appropriate for viewing of the user can be determined, so that the user's requirement for viewing can be satisfied without rotating the display screen. In particular, when the user of the panel personal computer changes and the viewing angle of the user also changes, the panel personal computer can directly switch to display the content at an angle being appropriate for viewing of a new user, without any operation of the user, which improves users' experience.

In another embodiment of the present disclosure, acquiring body feature information of a user in particular can further be acquiring position information of the user. In particular, a position of the user relative to a display screen can be acquired through an infrared photographic device or a sensor and so forth, for example, marking the position of the user in directions of top (upward), bottom (downward), left and right on a plane the same as the display screen and with the display screen as a center, i.e, determining in which direction of the screen a user (human body) is located. Then, position information of the user and pre-stored positioning information of display angles are compared, based on which a display angle of the terminal device can be determined. For example, if the position information of the user is that the user is located at the bottom of the display screen, a corresponding determined display angle is the display angle in the first state mentioned above; if position information of the user is that the user is located on the right of the display screen, a corresponding determined display state is the display angle in the second state mentioned above.

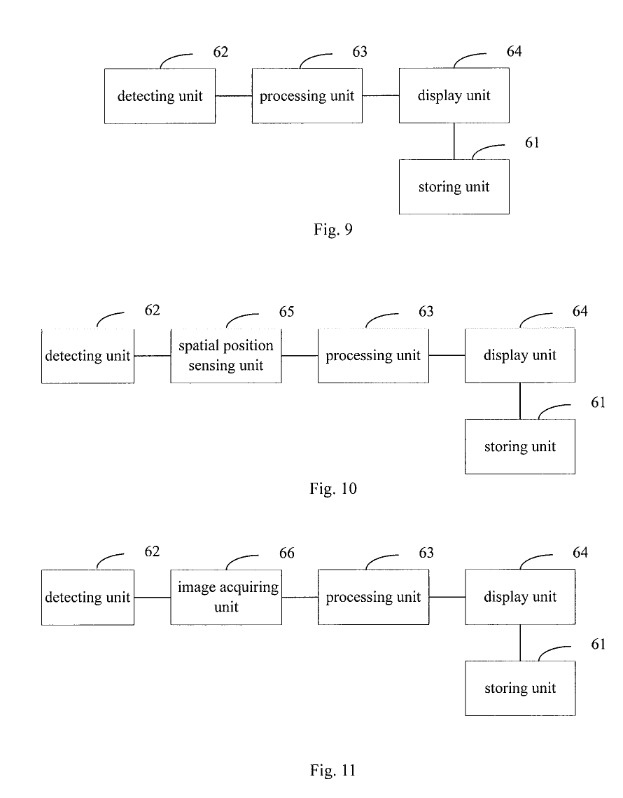

Based on the implementation process of the methods mentioned above, the embodiments of the present disclosure further provide a terminal device, of which an illustrative diagram of a structure is as shown in FIG. 9. The terminal device comprises at least a first state and a second state being differ from the first state. The terminal device comprises: a storing unit 61, a detecting unit 62, a processing unit 63 and a display unit 64, wherein the storing unit 61 is used for storing a first content and a second content of the terminal device, and objects included in the first content and objects included in the second content are not exactly the same; the detecting unit 62 is used for detecting a state of the terminal device; the processing unit 63 is used for producing a first display command when the detecting unit 62 detects that the terminal device is in the first state or producing a second display command when the detecting unit 62 detects that the terminal device is in the second state; and the display unit 64 is used for displaying the first content stored in the storing unit 61 according to the first display command produced by the processing unit 63 or displaying the second content stored in the storing unit 61 according to the second display command produced by the processing unit 63.

In the present embodiment, the detecting unit 62 is a micro torque sensor. It is set in advance that the first state and the second state correspond to their respective torque values. It can be detected that the torque value of the panel personal computer has changed when the panel personal computer is rotated. The state of the panel personal computer after the rotation of the panel personal computer can be determined according to the torque value of the panel personal computer before the rotation of the panel personal computer and the change of the torque value. In other embodiments, the detecting unit 62 is an image acquiring unit. The current display state of the panel personal computer can be determined through acquiring human face image information and then comparing the human face image information and the pre-stored positioning information of display states. There are two desktop systems set in the panel personal computer of the present embodiment. Each of the two desktop systems has a completely different content, and different application shortcuts are contained in the first content and the second content. Corresponding information of each of the display states, display commands and desktop systems is stored in the pane personal computer, for example, by means of a corresponding list. If it is detected that the current display state of the panel personal computer is in the first state, the processing unit 63 triggers to produce the first display command, then a desktop system corresponding to the first display command is obtained from the corresponding list according to the first display command, and further the display screen of the panel personal computer can display the first content of the desktop system; if it is detected that the current display state of the panel personal computer is in the second state, the processing unit 63 triggers to produce the second display command, then a desktop system corresponding to the second display command is obtained from the corresponding list according to the second display command, and further the display screen of the panel personal computer can display the second content of the desktop system.

The embodiments of the present disclosure has realized display of different contents in different display states by setting desktop systems corresponding to different display states in the panel personal computer and detecting a display state of the panel personal computer through the detecting unit. When being used by a user, the user can enter into different desktop systems as long as he/she rotates the display screen of the panel personal computer, which gives convenience to users' operation and improves users' experience.

Preferably, the terminal device can further comprise: a spatial position sensing unit 65 connected to the detecting unit 61 and used for acquiring spatial position information of the terminal device, determining whether the terminal device is in the first state or in the second state according to the spatial position information, and notifying the determined state to the detecting unit 61, please refer to FIG. 10 for its detailed illustrative diagram of a structure.

Preferably, the terminal device can further comprise: an image acquiring unit 66 connected to the detecting unit 61 and used for acquiring image information nearby the terminal device, determining whether the terminal device is in the first state or in the second state according to the image information, and notifying the determined state to the detecting unit 61, please refer to FIG. 11 for its detailed illustrative diagram of a structure.

Preferably, the terminal device can further comprise a spatial position sensing unit and an image acquiring unit, both of which are connected to the detecting unit and the processing unit.

Preferably, objects included in the first content or the second content displayed on the display unit are in a forward direction relative to a user.

Preferably, the first content displayed on the display unit comprises a first object and a second object; the second content displayed on the display unit comprises the first object and a third object, wherein the second object and the third object are different.

Preferably, a display position of the first object displayed on the display unit is placed in a first region of the display unit, and a display position of the second object or the third object is placed in a second region of the display unit.

Wherein the second region displayed on the display unit is an edge region if the first region displayed on the display unit is a central region; or the second region displayed on the display unit is a central region if the first region displayed on the display unit is an edge region.

Please refer to the descriptions of the method embodiments described above for the specific implementation process of each of units in the apparatus embodiments, details omitted.

The embodiments of the present disclosure has realized display of different contents in different display states by setting contents corresponding to different display states in desktop systems of the panel personal computer and acquiring human face image to determine a current display state so as to obtain the corresponding display content for display in the current state through the above units. When being used by a user, the user can enter into different desktop systems as long as he/she views the display screen in different ways to enable the display screen to acquire human face image, which gives convenience to users' operation and improves users' experience.

Further, the embodiments of the present disclosure, through the above units, acquire human face image information of a user and determine a viewing angle of the user, and then a display angle being appropriate for viewing of the user can be determined, so that the user's requirement for viewing can be satisfied without rotating a display screen. In particular, when the user of the panel personal computer changes and a viewing angle of the user also changes, the panel personal computer can directly switch to display the content at an angle being appropriate for viewing of a new user, without any operation of the user, which improves users' experience.

The embodiments of the present disclosure described above do not form a limitation to the protection scope of the present disclosure. Any modification, replacement or improvement without departing from the principle and scope of the present disclosure should be considered as falling into the scope sought for protection in the claims of the present disclosure.

1. A display method applied to a terminal device, and the terminal device comprising a display unit, wherein the terminal device comprises at least a first state and a second state being differ from the first state, the method comprises:
detecting a state of the terminal device;
producing a first display command when it is detected that the terminal device is in the first state, and displaying a first content on the display unit according to the first display command;
producing a second display command when it is detected that the terminal device is in the second state, and displaying a second content on the display unit according to the second display command;
wherein objects included in the first content and objects in the second content are not exactly the same.

2. The method according to claim 1, wherein the terminal device further comprises a spatial position sensing unit, and the method further comprises the spatial position sensing unit of the terminal device acquires spatial position information of the terminal device, and determines whether the terminal device is in the first state or in the second state according to the spatial position information.

3. The method according to claim 1, wherein the terminal device further comprises an image acquiring unit, and the method further comprises the image acquiring unit of the terminal device acquires image information nearby the terminal device, and determines whether the terminal device is in the first state or in the second state according to the image information.

4. The method according to claim 1, wherein the objects included in the first content or the second content displayed on the display unit are in a forward direction relative to a user.

5. The method according to claim 1, wherein the display command comprises a display object, a display position of the display object and a direction of the display object.

6. The method according to claim 5, wherein the first content comprises a first object and a second object; the second content comprises the first object and a third object, wherein the second object and the third object are different.

7. The method according to claim 6, wherein a display position of the first object is in a first region of the display unit, and a display position of the second object or the third object is in a second region of the display unit.

8. A terminal device, wherein the terminal device comprises at least a first state and a second state being differ from the first state, the terminal device comprises:
a storing unit used for storing a first content and a second content of the terminal device, wherein objects included in the first content and objects included in the second content are not exactly the same;
a detecting unit used for detecting a state of the terminal device;
a processing unit used for producing a first display command when the detecting unit detects that the terminal device is in the first state, or producing a second display command when the detecting unit detects that the terminal device is in the second state;
a display unit for displaying the first content stored in the storing unit according to the first display command produced by the processing unit, or displaying the second content stored in the storing unit according to the second display command produced by the processing unit.

9. The terminal device according to claim 8, wherein the terminal device further comprises a spatial position sensing unit for acquiring spatial position information of the terminal device, determining whether the terminal device is in the first state or in the second state according to the spatial position information, and notifying the determined state to the detecting unit.

10. The terminal device according to claim 8, wherein the terminal device further comprises an image acquiring unit for acquiring image information nearby the terminal device, determining whether the terminal device is in the first state or in the second state according to the image information, and notifying the determined state to the detecting unit.

11. The terminal device according to claim 8, wherein objects included in the first content or the second content displayed on the display unit are in a forward direction relative to a user.

12. The terminal device according to claim 11, wherein
the first content displayed on the display unit comprises a first object and a second object;
the second content displayed on the display unit comprises the first object and a third object;
wherein the second object and the third object are different.

13. The terminal device according to claim 12, wherein a display position of the first object displayed on the display unit is in a first region of the display unit, and a display position of the second object or the third object is in a second region of the display unit.

14. The terminal device according to claim 13, wherein the second region displayed on the display unit is an edge region if the first region displayed on the display unit is a central region; or the second region displayed on the display unit is a central region if the first region displayed on the display unit is an edge region.
